(19) United States
(12) Patent Application Publication
(10) Pub. No.: US 2005/0271128 A1
(43) Pub. Date: Dec. 8, 2005

(54) Distributed SCADA system for remote monitoring and control of access points utilizing an intelligent uninterruptible power supply system for a WISP network

(76) Inventors: Jeffery David Williams, Chico, CA (US); James A. Higgins, Chico, CA (US)

Correspondence Address: DLA PIPER RUDNICK GRAY CARY US LLP, 153 TOWNSEND STREET, SUITE 800, SAN FRANCISCO, CA, 94107-1907, US

(21) Appl. No.: 10/859,448

(22) Filed: Jun. 2, 2004

(51) Int. Cl. H04B 1/38

(52) U.S. Cl. 375/222

(57) ABSTRACT

An intelligent uninterruptible power supply (IUPS) for an access point (AP) within a wireless Internet service provider (WISP) network allows for the interaction with and integration of a supervisory control and data acquisition (SCADA) system. This results in an integrated wireless network management system allows for the control, monitoring and reporting of the system. The access points include at least one antenna, CPU, supporting passive and dynamic component electronics and an access point program module including volatile and/or non-volatile memory. Further, the IUPS includes one or more batteries, power regulation and charging circuits, logic circuits and a resident power supply program module for communication with the access point. Commands can be initiated remotely and status communication requests can be initiated either locally from the access point to the IUPS or from a remote central control console and relayed from the IUPS via the access point. The access point further acts as a liaison to the IUPS requesting status and event monitoring via a messaging protocol, and access point file system. The IUPS module is configured to trigger an automatic power supply cycling of the AP upon determination that the AP is not operating properly. The SCADA system configuration includes multiple components incorporating the concepts of centralized control and data acquisition, access point relays and their management via an IUPS and remote centralized control console.

### BACKGROUND

1. Field of the Invention

The invention relates to wireless networking, and particularly to a system and method for remotely monitoring and controlling an access point including an intelligent uninterruptible power supply.

2. Description of the Related Art

A wireless network includes backbone of access points that are RF connected. One or more of these access points ultimately connect to a gateway, which connects the wireless network to another network such as the Internet. Customer premise equipment (CPEs) connect to the wireless network by RF connecting to an access point. In some systems, access points are resident at customer premise location. Each access point includes its own power supply for powering the electronics, RF card and antenna located there.

Internet service providers (ISPs) utilize existing infrastructure that are leased from POTS (“plain old telephone companies”) or RBOCS (regional bell operating companies) over the public Switched Telephone Network (PSTN). These existing infrastructures tend to include twisted pair or co-axial cables of the telephone and cable companies, respectively. Thus independent ISPs do not own, build nor maintain these portions of the network that they use to provide Internet service to customers, rather they lease them in their entirety.

Alternatively, a wireless network company (WISP) that maintains its own access points including power supplies, electronics and antennas does not suffer from having to lease bandwidth or construct and maintain its own hardwired system. However, in exchange for those advantages, the wireless network typically is designed, the infrastructure constructed and the equipment maintained by the WISP.

In the past, a power supply including, e.g., a DC battery that is charged by an AC source through an AC power connection and an AC/DC converter, would simply supply power to the access point as a sole coupling to the antenna and supporting electronics resident at the access point. The only way to know whether the access point and associated power supply equipment was operating properly with this conventional system was to witness the symptom locally at the customer's or similar installation site. That is, previously, the way to find out whether power had been lost was to physically inspect the site, or receive a customer service call. It is desired to be able to know when a particular problem with the power supply or access point is about to manifest itself, so that preemptive actions can minimize network disruptions or even prevent them in advance.

One solution would be to have a monitoring program operating at a gateway that is configured for determining whether an access point is operational or not. Even having a tool such as this, if the access point is determined to be non-operational, then a physical inspection of the site would generally still be needed to reveal the problem. The problem might be a data problem, an RF problem or a power problem. Among potential data problems are software glitches, viruses or worms affecting the programming, memory crashes, etc. RF problems can include physical obstructions between antennas, or attenuation, degradation and/or other interference problems. Power problems for the access point equipment might involve a failure to receive adequate power from the power supply. A service person responsible for the repair would normally first have to diagnose a range of problems at the site. This can be a time consuming and costly effort given the myriad of possible problems. Only upon properly diagnosing the problem, or going through a series of universal steps designed to solve any of multiple common problems, could the service person effect the proper repair and get the access point back into operational mode. It is desired to have a system that permits remote monitoring, and management of access points and power supplies and power cycle control of access points to reduce or prevent access point downtime and/or repair costs.

### SUMMARY OF THE INVENTION

An access point of a wireless Internet service provider (WISP) network is provided in accordance with a first aspect of the invention. The WISP system includes a supervisory control and data acquisition (SCADA) system. The access point includes at least one antenna, supporting electronics, and further includes programming instruction modules and associated power supply unit. Program modules are resident at gateways, access points and power supply units that permit intercommunication and subsequent transmission of wireless signals to be received and transmitted along a backbone of the wireless network. The access point program module that is resident at the access point communicates with the power supply module. The access point module program acts as liaison between the gateway central control console of the WISP network and the power supply module allowing commands to be issued to the power supply unit and status variables retrieved from the power supply unit. The gateway central console, access point module and power supply unit communicate to maintain the access point and power supply unit in an operating mode within the network by identifying power supply or access point problems, or both, and preventing or reducing unplanned power supply disruptions and access point failures. The access point module manages the power supply unit and in return the power supply unit can initiate an access point shutdown or power cycle on the loss of an access point heart beat.

The power supply unit may process the commands relayed to it from the access point module program that initiated from the gateway central console. The power supply program further generates and senses internal events and measured variables and includes the ability to trigger a power cycling of the access point when the access point module is determined to not be operating properly or requires testing. The power supply unit may further be configured to process requests for status variables from the access point module, which in turn can be stored in the access point volatile memory.

The access point may further include volatile and non-volatile memory modules. A file system resident at the access point is contained within volatile addressable memory that allows for the storage of command and status files. Communication from the access point to the power supply module program may include automated commands and status requests. The access point command file may further include commands to the power supply unit such as status requests, firmware updates, combined EEPROM and Flash program updates, Flash program alone updates, heartbeat disable, battery date update, Mcu reset, or access point power cycle request or combinations thereof. The access point status file may be further configured to include storage of power supply unit status variables such as status, input/output and various voltage levels, load and battery current values, fuse, box access alarm, temperature, battery charge level, reset event counter, reset clock, firmware serial number or firmware filename, or combinations thereof. Resident in the access point non-volatile memory may be a program that generates a heart beat signal. The power supply program further can be configured to listen to the access point and upon detecting a loss of this signal in a programming routine, such as including a Pre-amble, assume that the access point has malfunctioned and that a power cycle sequence should be initiated.

A power supply of an access point of a wireless internet service provider (WISP) network is provided in accordance with a further aspect of the invention. The WISP network includes a supervisory control and data acquisition (SCADA) system. The access point further includes at least one antenna, supporting electronics and an access point programming instruction module. The power supply includes a power supply programming instruction module resident at the power supply for communicating with the access point module. Commands relayed to the access point module from the central control console that is resident at the gateway of the WISP network are processed. The power supply module further performs status sensing and logic programming configured to trigger access point power cycling when the access point equipment is determined to not be operating properly.

Processing an access point localized heart beat routine that facilitates the communicating with the access point module of the status sensing and communicating routine may also be performed by the power supply module. The gateway central console may initiate a power supply power cycling routine or Mcu reset via the access point command file, or both. When an expected heart beat signal is not detected by the power supply module then a power cycling of the access point would be initiated by that power supply module. The power supply module may also execute a battery test routine that checks and stores a battery voltage level periodically.

A gateway central control console of a wireless internet service provider (WISP) network is provided in accordance with a further aspect of the invention. The network includes a supervisory control and data acquisition (SCADA) system for monitoring and controlling a plurality of access points each including at least one antenna, a power supply, supporting electronics and access point program modules and power supply program modules. The gateway may include a network-connected workstation and centralized console enabling command line interface with the distributed network of access points and power supplies, including programming or configuration or protocol implementation for communicating commands to and receiving status between the access point and power supply modules. The intercommunication fabric is preferably provided via a standard messaging or transfer protocol such as HTTP or RPC or variant, with an interface at the gateway and access points that are configured to facilitate control of and status determination of access point and power supply operation. Communication is preferably established via protocols such as TCP/IP and enable the transmission commands and associated arguments between the access point web clients and server. Each web client preferably has a set of modules or plug-ins that are implemented based on the parameters and execute to provide the selected command and status functionality. The access point module communicates with the power supply module to automatically implement status requests in one or more localized routines. In this way, both remote centralized gateway control and monitoring is achieved via communication protocol plug-ins at the access point and local control of the access point is governed via the power supply console, along with the automatic status indication accumulation initiated by the access point. Thus in addition to this functionality it combines to allow for the efficient management of network traffic, which avoids greatly an increase in the network traffic overhead component.

The commands communicated to the access point by the gateway console may include a status request that initiates a local sub-routine at the access point resulting in the writing to a status file that is accessible and allows reporting and graphing of operational variables and alerts. The commands communicated to the access point by the gateway console may also result in one or more programming instruction update commands being initiated, such as power supply module firmware update commands. The action requests communicated to the access point by the gateway console may include an initiation of the power cycling command and/or an power supply programming reset command via the access point command file, or both. The access point programming may comprise the power supply interface programming plus gateway central control console interface programming.

A supervisory control and data acquisition (SCADA) method is also provided for monitoring and controlling from a centralized gateway workstation console a plurality of access points each including at least one antenna, a power supply, supporting electronics and access point programming and power supply programming instruction modules. The method includes running an access point program module that is resident at the access point. Centralized access point control is exercised including communicating commands to and receiving status from the access point program module. The access point program module communicates with the power supply program module to automatically implement the commands from the gateway console via the access point program module in one or more localized routines, thereby enabling centralized console control while avoiding greatly increased network traffic.

A status request command may be communicated that initiates a localized sub-routine at the access point resulting in an updating of a status file that is accessible at the gateway console or by virtue of the monitoring protocol plug-in resident at the access point. One or more programming instruction update commands may also be communicated, such as power supply module programming update commands. An automatic power cycling command may also be communicated to the power supply module via the access point command file, and/or a power supply programming reset command, or both, may be communicated via the access point. The method may also include communicating a status request command to the access point, receiving a power supply status, and communicating to the access point a power cycling command, or power supply programming reset command, or combinations thereof.

A method of operating an access point of a wireless Internet service provider (WISP) network is further provided in accordance with another aspect of the invention. The network includes a supervisory control and data acquisition (SCADA) system. The access point includes at least one antenna, a power supply and supporting electronics, as well as power supply and access point programming instruction modules. The method includes energizing a power supply for the access point permitting wireless signals to be received and transmitted including running a power supply programming module resident at the power supply, and running an access point programming module resident at the access point. Commands are communicated via the access point command file to the power supply programming module that are relayed from a console that is resident at a gateway of the WISP network. The method also includes communicating commands to the power supply module via the access point module based on status signals from the power supply module for maintaining the access point in an operating mode within the network by limiting unplanned power supply disruptions.

An automatic power cycling may be triggered when the access point equipment is determined to not be operating properly. A power supply programming reset routine, may also be initiated from the access point module. An access point pre-amble signal may be generated that serves as a heart-beat to prevent a power cycling command from being triggered as long as the heart beat signal is observed. That is, a power cycling command may be triggered when the heart beat is not observed. The commands from the access point module program may include a status request command, a calibration command, one or more programming instruction updating commands, a heart beat function override command, a power cycling command or an access point programming or a power supply programming reset command, or combinations thereof.

A method of operating a power supply of an access point of a wireless internet service provider (WISP) network is further provided in accordance with another aspect of the invention. The network includes a supervisory control and data acquisition (SCADA) system. The access point further includes at least one antenna, supporting electronics and an access point programming module. The power supply includes a power supply programming module resident at the power supply. The method includes communicating with the access point programming module to process commands relayed to the access point programming module by console interface that is resident at the gateway of the WISP network. A power supply status is sensed and communication between the power supply module and the access point module is performed for triggering an automatic power cycling routine or a power supply programming reset routine, or both, or other access point equipment is determined to not be operating properly.

The method may also include processing an access point local heart beat routine that facilitates the communicating between the access point modules and sensing by the power supply module. A power cycling routine may be communicated when an expected heart beat signal is not received from the access point module. The power supply module may also include executing a battery test routine including checking and storing a battery voltage level periodically, or processing a power cycling command, or a power supply programming reset command, or combinations thereof.

One or more processor readable memory storage devices are also provided having processor readable code embodied thereon. The processor readable code programs one or more processes to perform any of the methods described above.

### BRIEF DESCRIPTION OF THE DRAWINGS

FIG. 1 schematically illustrates a wireless network configuration in accordance with a preferred embodiment.

FIG. 2 schematically illustrates a connected series of access points within the wireless network of FIG. 1.

FIG. 3 schematically illustrates a configuration of one of the access points of the wireless network of FIG. 1.

FIG. 4 schematically illustrates a digital electronic configuration of a power supply of an access point of the wireless network.

FIG. 5 schematically illustrates a battery charger circuit of a power supply of an access point of the wireless network.

FIG. 6 schematically illustrates a power control circuit of a power supply of an access point of the wireless network.

FIG. 7a schematically illustrates a monitoring module plug-in including a protocol stack for a SCADA system for power supply monitoring and control in a wireless network in accordance with a preferred embodiment.

FIG. 7b illustrates an exemplary processing flow for the protocol stack of the SCADA system of FIG. 7a.

FIG. 8a is a flow diagram illustrating data acquisition and processing at an access point of a wireless network in accordance with a preferred embodiment.

FIG. 8b shows exemplary contents of the gateway main program command file of FIGS. 7a and 7b.

FIG. 8c shows exemplary contents of a power supply module status file and/or the status file of FIGS. 7a and 7b.

FIG. 9 illustrates several power supply status sub-routines of the data acquisition and processing at the access point.

FIG. 10 illustrates a preamble sub-routine of the data acquisition and processing at the access point.

FIG. 11 illustrates a boot-loader sub-routine of the data acquisition and processing at the access point.

FIGS. 12a and 12b illustrate burn EEPROM and burn Flash sub-routines of the data acquisition and processing at the access point.

FIG. 13a is flow diagram illustrating data acquisition and processing at a power supply of an access point of a wireless network in accordance with a preferred embodiment.

FIG. 13b illustrates a set of gateway main program commands that may be implemented by data acquisition and processing at the power supply.

FIG. 14 illustrates a heart beat sub-routine of the data acquisition and processing at the power supply.

FIG. 15 illustrates a battery test sub-routine of the data acquisition and processing at the power supply.

### INCORPORATION BY REFERENCE

What follows is a cite list of references each of which is, in addition to that which is described as background and the invention summary, hereby incorporated by reference into the detailed description of the preferred embodiments below, as disclosing alternative embodiments of elements or features of the preferred embodiments not otherwise set forth in detail below. A single one or a combination of two or more of these references may be consulted to obtain a variation of the preferred embodiments described in the detailed description herein:

U.S. Pat. Nos. 5,463,671, 5,574,775, 5,648,969, 5,661,723, 5,778,116, 5,787,080, 5,822,324, 5,867,485, 5,907,062, 5,936,949, 5,960,344, 5,970,062, 5,983,068, 6,009,096, 6,014,546, 6,049,593, 6,069,885, 6,154,461, 6,198,728, 6,215,779, 6,249,516, 6,259,898, 6,272,120, 6,314,163, 6,323,980, 6,405,058, 6,452,915, 6,496,105, 6,512,755, 6,560,213, 6,578,085, 6,591,084, 6,640,100, 6,665,536 and 6,711,512; and

United States published patent applications nos. 2003/0185169, 2002/0152303, 2002/0032799, 2002/0018456, 2002/0018455, 2002/0015402, 2002/0015397, 2001/0055298, and 2001/0045914.

### DETAILED DESCRIPTION OF THE PREFERRED EMBODIMENTS

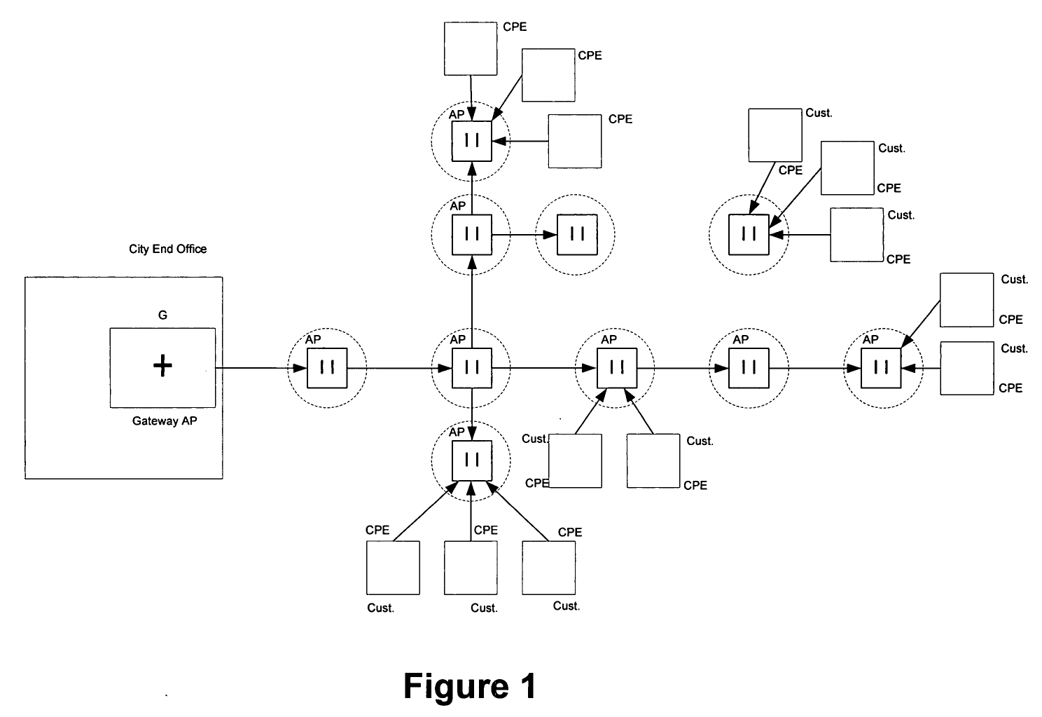

FIG. 1 schematically illustrates a wireless network configuration in accordance with a preferred embodiment. A gateway G is shown permitting access by the wireless network to another network such as the internet. A central control console is preferably a workstation running a gateway-resident messaging protocol that permits supervisory control and data acquisition (SCADA) of the distributed network components in a centralized manner. Although the central control console is preferably a workstation connected at the gateway G, the central control console may be located at any location having network access, either remote from an access point being monitored or at the location, and either by wired or wireless connection. Multiple gateways G may be operated in a similar manner by a same or different wireless internet service provider (WISP) either independently or in conjunction and/or communication with each other. Although the gateway G of FIG. 1 is shown RF signal coupled with a single access point AP for simplicity of illustration, in general, multiple access points and associated devices may couple through the gateway G to the internet or other network. The RF signal coupling preferably utilizes the standard, 802.11a, 802.11b/g communications protocols in the 5 and 2 GHz frequency bands respectively. Several other details of the preferred wireless internet access system (WIAS) are provided at United States published application no. 2003/0185169, which is assigned to the same assignee as the present application and is hereby incorporated by reference for all purposes.

Multiple access points AP are shown in FIG. 1. Each is connected on the backbone of the network to other access points such that customer premise equipment (CPE) that are connected to any access point AP in the network can send and receive communications along the network through the gateway G to the internet. RF media transmission points (relays) including access points AP are preferably wirelessly connected within the network backbone, although one or more transmission points may have hardwire interconnection, and in the unusual event that transmission points are proximately located, then a hardwire Ethernet connection may be utilized. Successive access points AP are preferably connected by communications between a directional antenna of one AP and an omni-directional antenna of a next successive AP. For example, a directional antenna at the gateway G may serve to connect with omni-directional antennas of the most upstream APs in the network, or vice-versa. Note that each of these antennas is preferably di-polar panel, but any of various antenna designs may be used as understood by those skilled in the art. Next, directional antennas of these most upstream APs may connect with omni-directional antennas of successive downstream APs, etc. Certain APs may have multiple directional antennas for connecting with omni-directional antennas of multiple downstream APs. There are various other possible ways that the antennas may be used to connect APs including directional-to-directional and omni-directional-to-omni-directional throughout the network. Each access point AP includes supporting electronics and bridging and/or routing hardware and programming instructions, preferably as provided on the Linksys bridging card model no. WRT45G. FIG. 1 further shows multiple CPEs connecting to the various APs of the network. The CPEs typically utilize a directional antenna to connect with the RF component of an omni-directional antenna of the AP, although they may connect via an omni-directional antenna, and they may connect with either of the directional or omni-directional antennas of the AP.

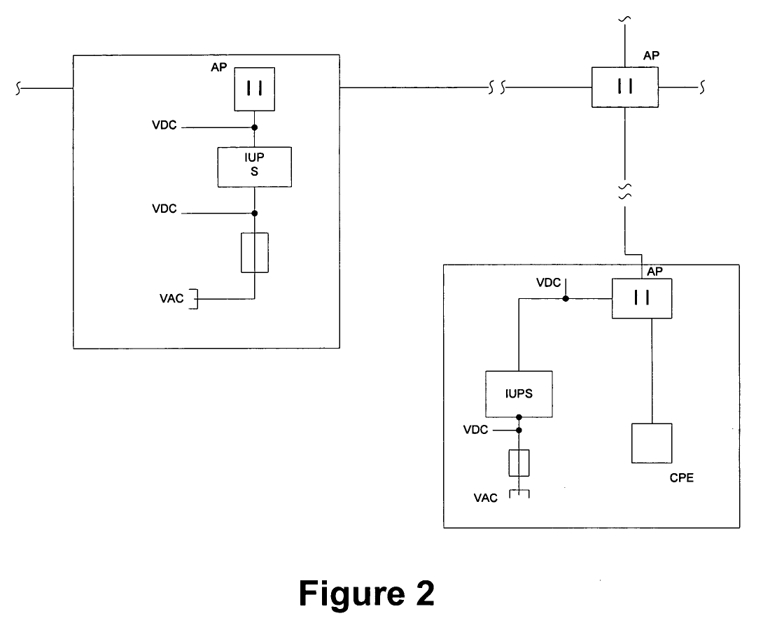

FIG. 2 schematically illustrates a connected series of access points within the wireless network of FIG. 1. FIG. 2 illustrates some of the detailed design of the access points AP. AC power (110V) is shown as the basic energy source which is converted to DC by an AC/DC converter prior to energizing the intelligent uninterruptible power supply (IUPS) with direct current voltage (which is used to mostly continuously maintain the charge on one or more batteries within the power supply). A regulated DC voltage is applied from these batteries of the IUPS to the access point AP.

FIG. 1-2 are illustrative of an access point AP and customer premise equipment CPE arrangement. It is noted that the access point AP and CPE and their components may be variously arranged. For example, the access point AP and CPE may be combined into a single unit, and may be physically combined into a same enclosure. A single power supply IUPS or separate power supplies IUPS may be used to power separate or combined AP and CPE units.

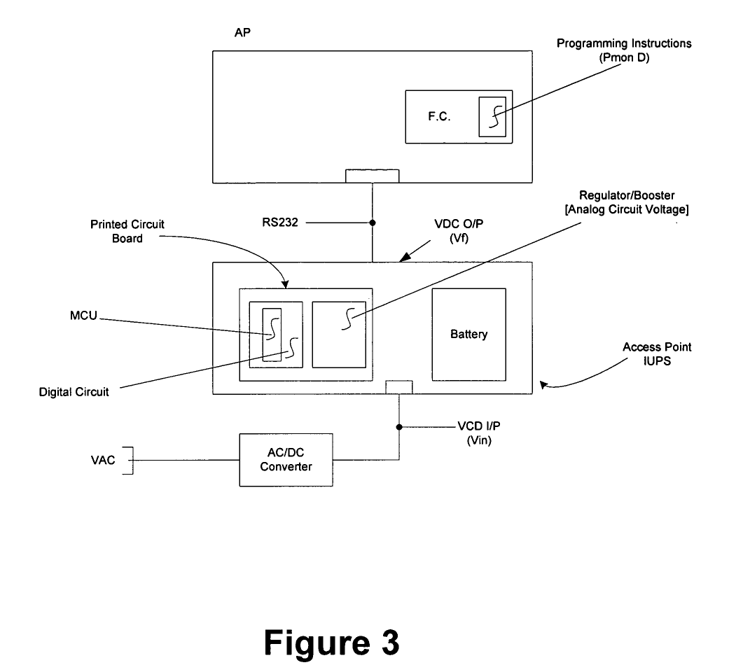

FIG. 3 schematically illustrates a single access point configuration in accordance with a preferred embodiment. The antennas and the bridge card that are components of the access points shown in FIGS. 1-2 are left out of FIG. 3 for simplicity. The components shown in FIG. 3 are those that are used in the SCADA functionality of the WIAS. FIG. 3 shows the power supply UPS and a flash card resident at the AP connected by an RS232 connection. Although not shown in FIG. 3, the access point AP preferably includes a CPU and other electronics including volatile and non-volatile memory. The non-volatile flash card memory includes programming instructions that implement a heart beat function that will be described below in conjunction with further control and status monitoring features for both localized communication and processing with the power supply IUPS and as components that facilitate centralized SCADA functionality and communication with the gateway workstation console monitoring/messaging protocol.

The power supply IUPS includes a battery that provides regulated DC voltage to the access point AP so that signals may be sent and received from its one or more antennas, preferably including both an omni-directional antenna and a directional antenna, and so that local and remote SCADA sub-routines may be run. Power is supplied for recharging the battery from a 110V AC supply. The AC voltage is transformed prior to the circuit board for supplying the circuit board with DC voltage. The AC/DC converter is shown in FIG. 3 symbolically outside the power box enclosure. This AC/DC converter may be located inside or outside the box, attached to the frame of the box, or otherwise disposed in or around the box. The AC/DC converter is electrically coupled to electronics of the power supply IUPS, and may be mechanically-coupled, signal-coupled or otherwise with one or more components of the power supply IUPS.

In an alternative embodiment, solar power may be acquired using photovoltaic cells, solar panels or the like, either instead of or in conjunction with using AC power (e.g., for an emergency cell phone station). If solar power is used, then the solar power would be converted to Vin and the components of the power supply including the battery would be preferably otherwise the same as those shown in FIG. 3, or modified accordingly to utilize otherwise standard solar power components as understood by those skilled in the art. If there are no outlets, such as on a highway or otherwise away from electrical power lines or generators, then the system would not utilize and may not even have a VAC plug-in (or may only have one for use with a portable generator). These systems may be on wheels or may be otherwise transportable.

The circuit board is shown in FIG. 3 alongside the battery. The circuit board of the power supply IUPS preferably generally includes nine main modules. These modules utilize both active and passive components including digital and analog circuitry. These modules generally include those for serial communication, digital sensing, digital logic including the micro controller unit (Mcu), a local manual control interface, local indication, input and output switched power control, a battery charger and VDC boosting/regulating. For convenience, the micro-controller unit Mcu and digital circuitry may be considered as a single component. The Mcu implements a power supply program module CHmon that communicates with the access point program module PmonD preferably resident at a flash card. The power supply module CHmon listens for the PmonD heart beat sub-routine at the access point programming module in addition to running its own power supply status and measurement procedures.

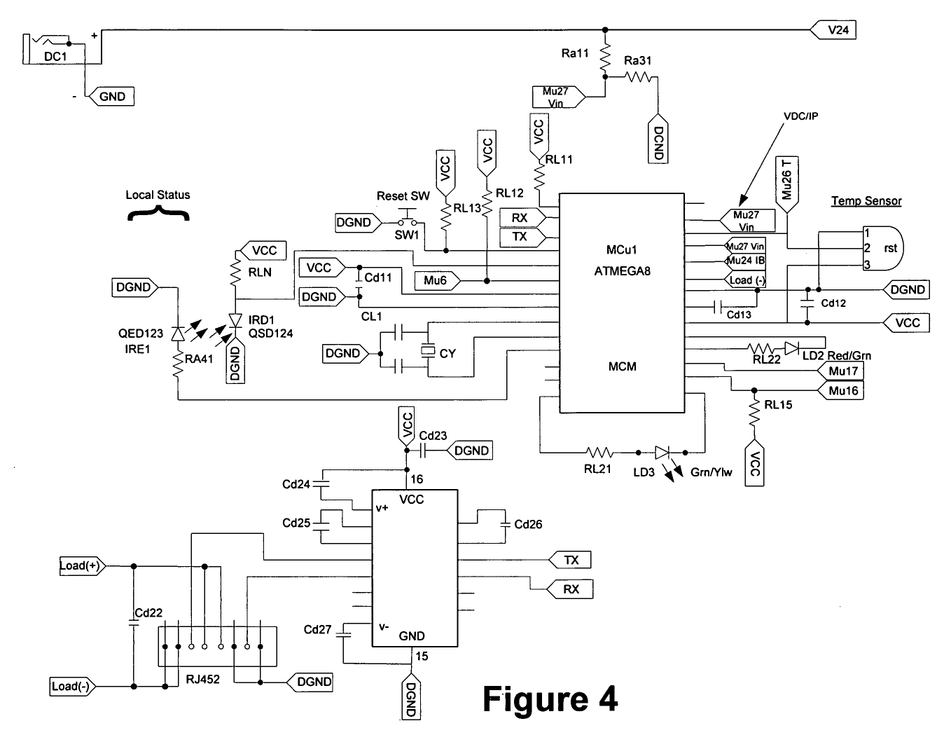

The access point flash card programming module facilitates communication between itself, the IUPS and the central console monitoring protocol resident at the network gateway in multiple ways. The IUPS CHmon programming module listens for a heartbeat provided by the access point flash card programming module. The access point heartbeat is a timed sequence of ASCII characters that are communicated from the flash card to the Mcu resident programming module. When this digital circuit senses the existence of the heart beat, it interprets the status of the access point to be normal. When the digital circuit does not sense the existence of the heart beat, and the status is thereby determined to be varied from normal to an invalid state or to not be operating properly, then it may initiate an automatic Mcu reset and/or a complete power cycling of the associated access point. The Mcu initiated power cycling via solid state switching results in a hard or cold rebooting of the access point and the resident operating system. The Mcu initiated reset is performed when it is sufficient to rectify the access point malfunction or other programming instruction-based problem. The IUPS circuitry and Mcu module performs functionality including clock, serial communication, heat beat monitoring, IUPS physical parameter and/or variable sensing, event recognition and/or monitoring, calculations, local status indication and local measured parameter storage. Also the access point programming module issues commands and requests to the IUPS programming module and in return receives and/or reads output status results and stores them in the access point status file. PmonD reads from the access point command file and writes these commands to the IUPS programming module. Conversely it also reads the status variables from the IUPS and writes these status values to the access point status file. The IUPS digital circuitry also provides local status indication via a number of LEDs. The digital circuitry of the circuit board of the power supply is illustrated in electrical schematic form at FIG. 4 in accordance with a preferred embodiment.

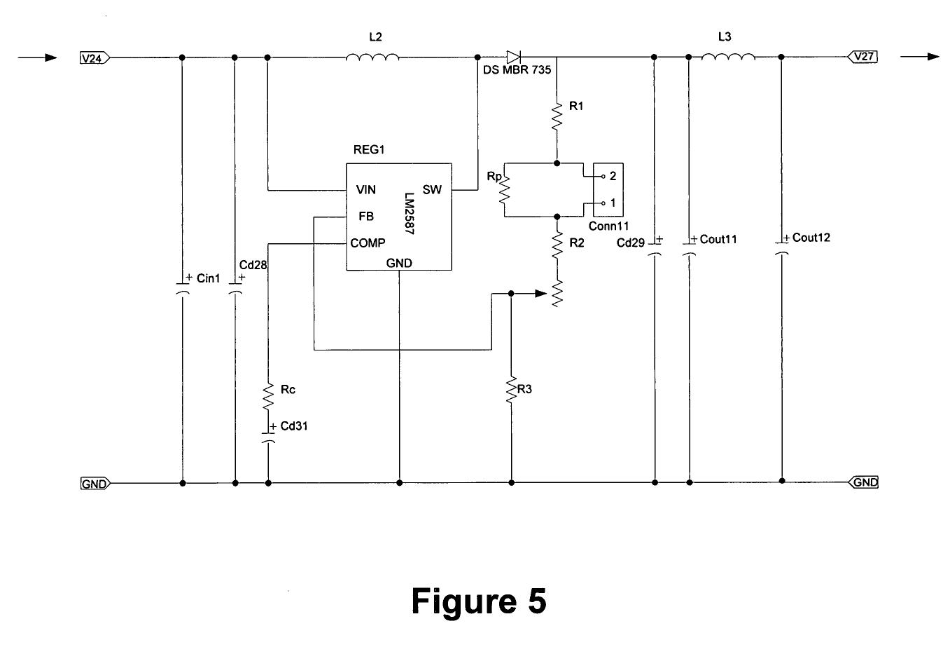

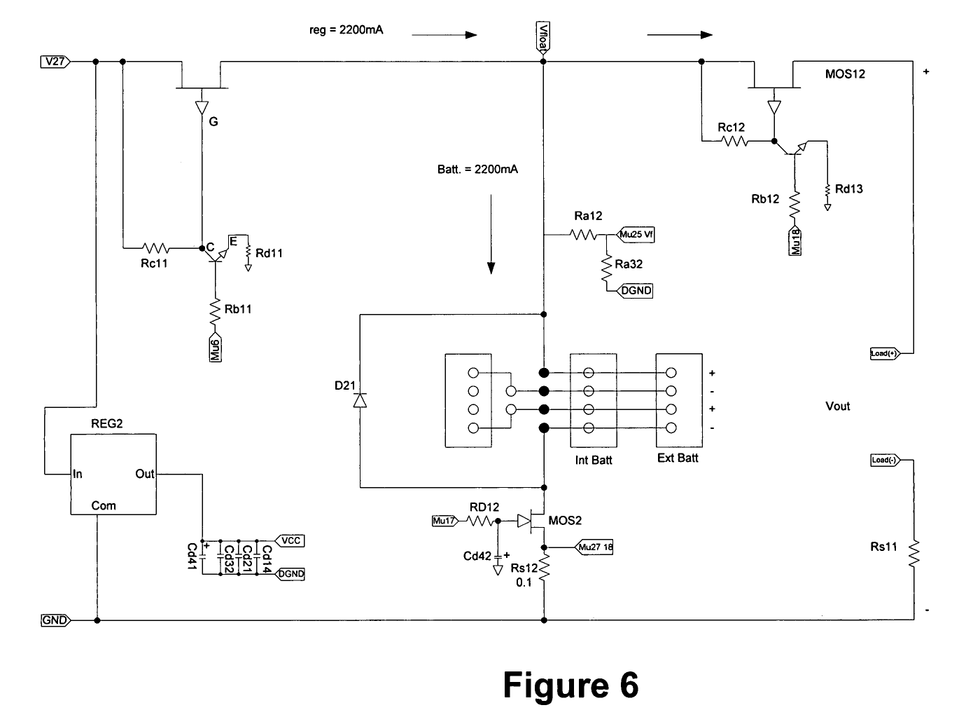

Another function performed by the circuitry of the power supply IUPS is to facilitate the charging of the battery by the input DC voltage Vin. The battery charging circuitry is schematically illustrated at FIG. 5. A majority of the battery charger circuitry is comprised via passive and dynamic electronic components. The circuit of FIG. 5 boosts the DC voltage Vin to provide the charging function. Any of a variety of conventional voltage boosting/regulation designs or techniques may be used, even though one example of such a circuit is provided at FIG. 5.

Another function performed by the circuitry of the power supply IUPS is to regulate the DC voltage that is provided to the functional access point electronics. Any of a variety of conventional voltage regulator designs or techniques may be used, even though one example of such a circuit is provided at FIG. 5.

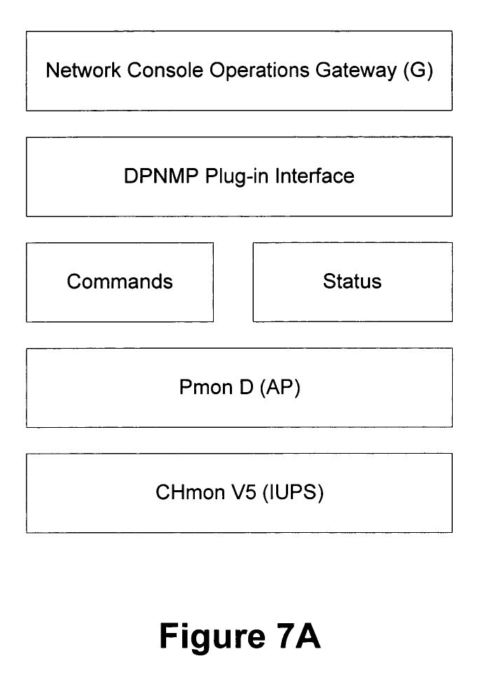

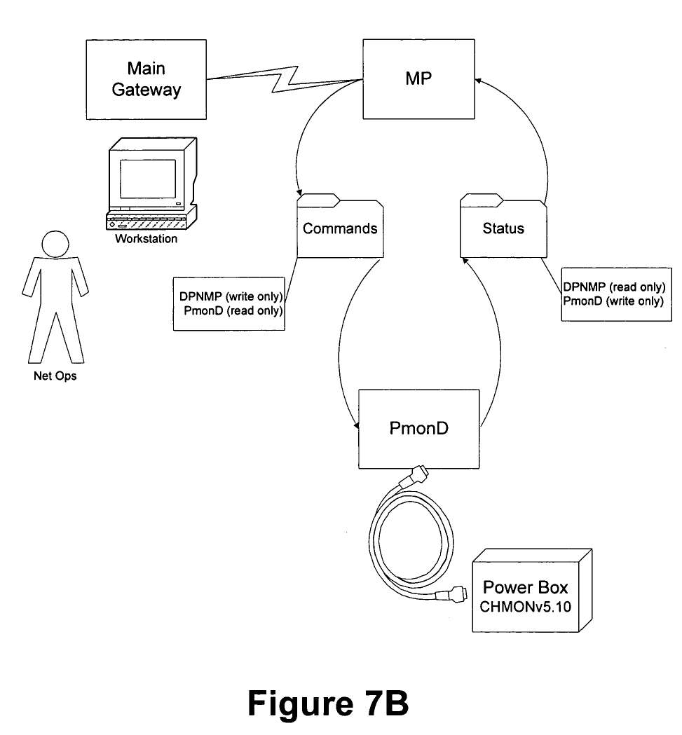

FIG. 7a schematically illustrates a protocol stack for a SCADA system for power supply monitoring, control and access point power cycling in a wireless network in accordance with a preferred embodiment. At the top of the stack is the network operations gateway central control console G. This includes the console from which commands are issued and network information is accessed, stored and reports are generated. A central console at the gateway G provides centralized monitoring, reporting and control of power supplies IUPSs and power cycling of APs. These include a series of implementations that transfer status information from the IUPS to the central console via the AP and commands to the IUPS from the central console via the AP.

From the central console commands are issued and requests for status made via a command file and status file, or provides pointer addresses to a command table, or otherwise instructs the access point programming instruction module PmonD to initiate procedures according to those commands. The PmonD preferably resides at the access points and directly communicates to a particular power supply programming instruction module CHmon that executes at the power supply, and is preferably resident within the power supply box, that powers the access point preferably at which the particular PmonD access point programming resides. Generally, PmonD serves the following primary operations: (i) sends a heart beat to CHmon that signals normal operation, (ii) requests and receives status information to and from CHmon via the status file, (iii) transfers commands from the central console to CHmon via the command file. The PmonD module is part of a total monitoring information network and acts as liaison between the central console and the IUPS.

The AP program module PmonD works in conjunction with the power supply programming instruction module CHmon to execute those commands and/or PmonD simply acts as an interface from which CHmon receives the commands from the gateway central console. The CHmon module preferably resides in circuitry and an embedded micro-controller Mcu that controls power output and availability to the access point, sends status information, and receives commands. When the command includes a status request, PmonD requests and writes the status to a status file, or provides pointer addresses to a status table, or otherwise provides the central console information sufficient that the status information may be accessed or read. Typically CHmon senses the various measured variables used to determine an overall status of the power supply.

FIG. 7b illustrates an exemplary processing flow for the protocol stack of the SCADA system of FIG. 7a. FIG. 7b represents an illustrative example of a data flow among a variety of ways to implement the SCADA system. The central console at the gateway workstation is shown as the user interface. The PmonD access point program module via a Monitoring Protocol plug in is configured to read commands from a command file, as entered by an operator at the workstation console. The access point module PmonD having then read the command file will interact with CHmon writing the command instructions to it. PmonD thus communicates with the power supply module CHmon to perform processing in accordance with any commands that PmonD may have read from the command file that has been initiated by the user from the gateway console. Conversely PmonD writes to the status file automatically. When the status changes periodically and/or when a command specifically requests status, then PmonD reads the status information from CHmon and writes the new status quantities to the status file. The status information within the status file is then available to the workstation console for storage and reporting of status and alerts.

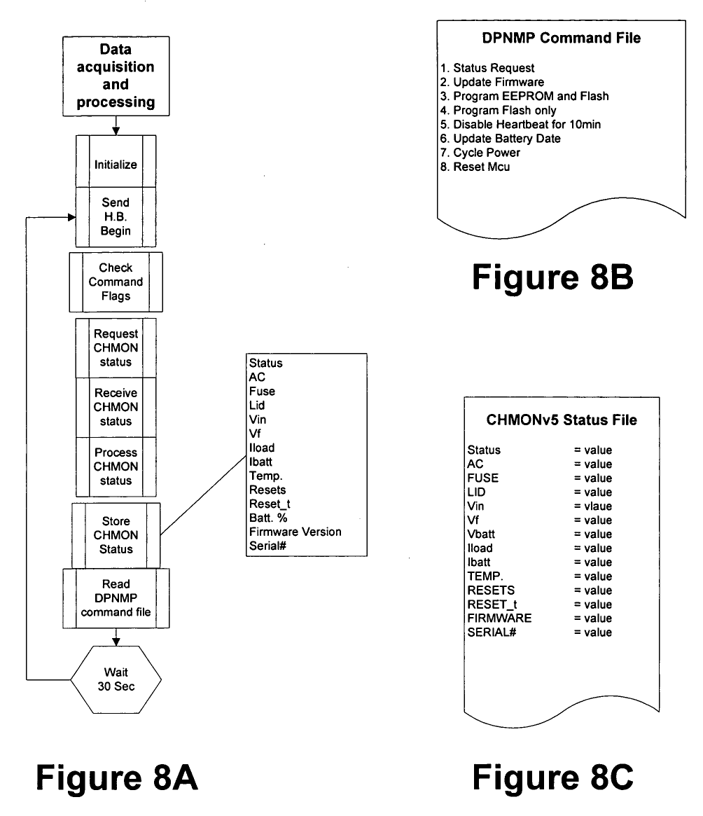

FIG. 8a is a flow diagram illustrating the control, data acquisition and processing at an access point of a wireless network in accordance with a preferred embodiment. The access point programming instructions PmonD are preferably written onto a flash card that is resident at the access point AP, and may alternatively be embedded as firmware or software onto a variety of machine-readable media. The PmonD programming is preferably configured to periodically run a control, data acquisition and processing routine as illustrated by the flow or block modular diagram of FIG. 8a. The blocks are provided in a logical sequential ordering, but those skilled in the art understand that the ordering may differ and/or multiple modules may be run contemporaneously.

The exemplary routine of FIG. 8a initializes when the system is powered up. The programming may be configured such that PmonD runs the initialization sub-routine also when the instruction set for the Mcu is reset at the power supply and/or may initialize in response to a command received from the gateway main console separate from a Mcu reset command. The initialize module preferably involves handshaking with the power supply program module CHmon via serial port protocol communication. Once initialized, PmonD sends a heart beat H.B. to be detected by the power supply module CHmon that lets the power supply module know that the access point module PmonD is operating properly. That is, PmonD is designed to periodically always send the heart beat during normal operation unless it receives a disable heart beat command from the gateway central console.

The next module that PmonD runs is a check command flags routine. The command flags may be checked within access point resident programming, or one or more tables or other data storage mechanisms resident at the access point. The command flags may have default values set during initialization that may be changed by commands written to the command file by the gateway console. The flags may be selectively changed, multiple ones may be changed in a single cycle, or they may be changed or rewritten as a group.

Next, a CHmon status request routine serves to send a signal to the power supply module CHmon to perform various sensory or measurement routines to determine various quantities associated with the power supply. PmonD reads the status entries from the CHmon status routine, then PmonD processes the status data that it has received from CHmon and stores it in the access point status file.

Among the quantities that may be preferably stored following the CHmon sensing and status receiving and processing by PmonD are status, AC, Lid, Vin, Vf, Iload, Ibatt, Temp., resets, reset_t, batt %, firmware version and serial #. Some of these are self-explanatory. “Status” is the overall status determined by the process CHmon status module. “AC” is a determination regarding the input AC power is determined by the input VDC by proxy, e.g., whether the 110 V input is hot or cold, or whether 220 V may be in use at this site. “Fuse” is a status of the fuse within the power supply, e.g., whether it is functional or not. “Lid” is a status of a lid of the power supply box, e.g., whether it is open, closed and locked, or closed and unlocked. “Vin” is the DC voltage that is being applied at the circuit board of the power supply unit, and may include one or more further voltages present within the circuit board and/or the output voltage that is charging the battery. “Iload” is the current across the access point equipment that is being powered by the power supply UPS in order that the antennas are able to send and receive RF signals. “Ibatt” is the current to the battery. “Temp” is the temperature within the power supply box, and may include multiple thermal measurements at key components or just a single reference temperature. “Batt %” is the percentage of maximum charge presently measured across the battery terminals. Because the battery is being charged by the AC/DC converted external power, the battery should not fall much from its maximum voltage other than according to the temperature, which is itself measured, and according to the ordinary life of the continuously-charged battery. “Resets” are the number of power cycles initiated within the time interval reset_t within the power supply system, and “Reset_t” is a reset of the 24 hr clock that coincides with the Mcu reset, which is also an indicator if the heard beat has timed out. “Serial #” and “firmware” are power supply and product specific indicators, respectively.

The final block, module or sub-routine of the overall routine of FIG. 8a is a read main program command file. The routine is defaulted to wait 30 seconds before running again, but the time may be shorter or longer to meet system needs. The CHmon status request, receive, process and store blocks may be preferably always running separate from whether any status request is present in the command file, and the status file of FIGS. 7a and 7b may be written to, or pointer address provided, etc., either by default or only when a status request command is received from the gateway central console. Alternatively, as a default the command file read by PmonD's based on the reset request flag may be set to send an additional request on top of the automatic loop routine. Also in this latter case, the gateway console workstation should be configured to automatically send a status request command periodically, or otherwise, a human operator should be trained to run status checks often, or more preferably, the status request may be turned back on following whatever routines are being run that prompted it to be turned off originally.

FIG. 8b shows exemplary contents of the command file of FIGS. 7a and 7b. The eight commands listed are not intended to be exhaustive, nor are all intended to be required. They are (1) status request, e.g., as described above, (2) update firmware, e.g., that is preferably resident at the power supply and contains the power supply programming instruction module CHmon, (3) update EEPROM or flash, e.g., that is preferably resident at the power supply firmware of the Mcu, (4) program flash only, (5) disable heart beat for 10 minutes, or a different time or until again enabled, (6) update battery date, e.g., when the battery is changed so that the system will know when it is time to change the battery again and if the battery has a normal operating voltage based on time and also on the measured temperature, (7) cycle power, e.g., powering down the entering access point by switching off the power supply circuit and them switching it back on (serving to re-initialize the entire system typically in the event of an unknown glitch), and (8) reset Mcu, e.g., when it is determined that a software problem is responsible for an abnormal operation or when programming instructions have been updated, the reset would be performed to initialize the updates.

FIG. 8c shows exemplary contents of the power supply module status file preferably resident at the access point. All of these have been just described briefly in reference to the programming logic of the CHmon module of the routine of FIG. 8a. As discussed above, these may be the same as the those of the status file of FIGS. 7a-7b, or may be those that are updated according to the periodic running of the routine of FIG. 8a while the status file of FIGS. 7a-7b may be alternatively automatically written to upon PmonD instruction to do so.

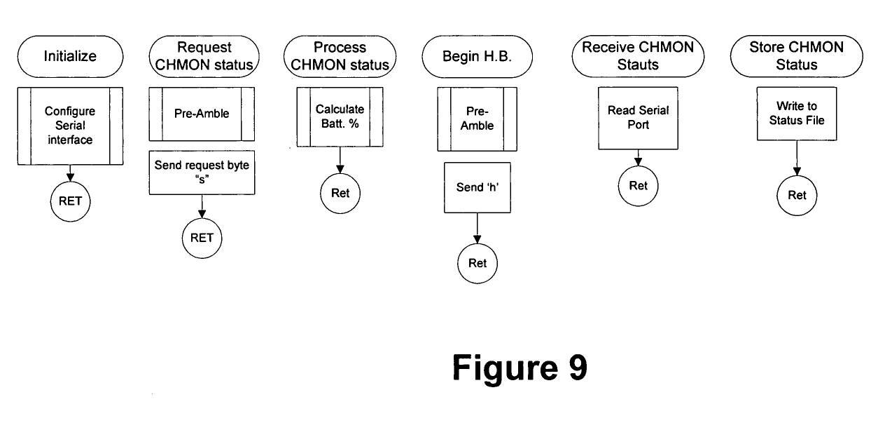

FIG. 9 illustrates several power supply status sub-routines of the data acquisition and processing at the access point. The sub-routines are those that were introduced above with reference to FIG. 8a, and are illustrated in some greater detail at FIG. 9.

The initialize module is shown including a serial interface configuration procedure for communicating with the power supply module CHmon. Further initialization routines may be included such as may be useful for writing status and reading commands depending on how this is performed in a particular system, or so that coupled access points may communicate, or to communicate with a client computer of a connected CPE, or to communicate with a mobile repair truck, in addition to the central console etc.

The request CHmon status module is shown including a pre-amble block. This pre-amble block may be that which is generated by PmonD and interpreted as a heart beat signal by the power supply programming module CHmon, which is listening for it. It has the same purpose as the pre-amble associated with the heart beat, and that is to ensure the proper commands and data are transferred to the power supply module CHmon and the status data from CHmon to the access point module PmonD. The pre-amble also reduces the threat of CHmon responding to an invalid command and entering an unstable state. Preferably, the sending of a pre-amble signal to CHmon prompts an acknowledge signal to be sent from CHmon to PmonD, such that CHmon is then expecting a command or heart beat and PmonD knows that CHmon is expecting to receive the command or heart beat within a certain time. The PmonD programming may instruct it not to send the command until it receives an acknowledge signal from CHmon, and if no acknowledge is received, then processing may be further provided along the lines of checking whether the power supply module is operating properly and/or initiating a Mcu reset or cycle power routine unless communication has failed.

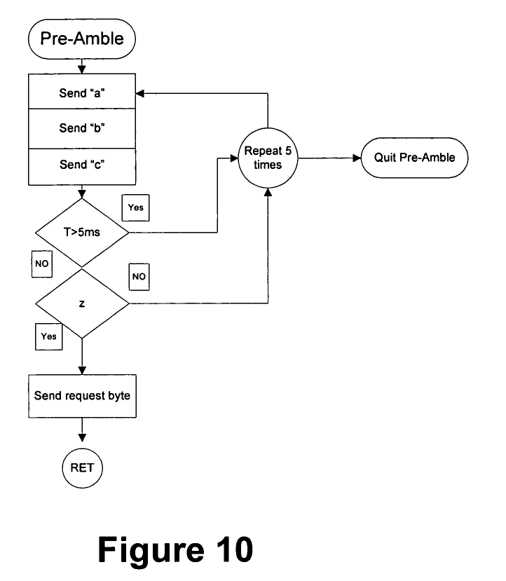

Referring briefly to FIG. 10, a preamble sub-routine of the data acquisition and processing at the access point is illustrated in further exemplary detail. The ascii characters “a”, “b” and “c” may be generated by PmonD as pre-amble code characters. The CHmon program is listening for this signal. Upon waiting a predetermined time, if there is no acknowledgement of the pre-amble received from CHmon, then the sending of the ascii characters is repeated, e.g., five times. If CHmon sends the acknowledgement, e.g., in the form of the ascii character “z”, or upon other such proper pre-amble acknowledgement being received at PmonD, a status request byte is sent to CHmon, e.g., as ascii character “s”. In the event that the pre-amble routine is quit and there is no acknowledgement received, then the programming could be configured to issue a power cycling command, or an access point programming, or Mcu reset, or PmonD may be configured to initiate the reset itself or to notify the gateway main program that there is a problem.

Referring back to FIG. 9, a process CHmon status sub-routine is shown including a calculate battery % module. Note that the calculate battery % sub-routine may be included within the CHmon programming or PmonD programming or both. This calculation involves many of the status quantities received from CHmon. They may be based upon sensing operations performed by CHmon in the status request routine. This status processing routine may also include one or more power status calculations that may again be performed either by CHmon or PmonD. The batt % calculation may be based upon or compared with an expected batt % value depending on the temperature and time from battery installation, and perhaps other factors as understood by those skilled in the art. If the batt % is below a threshold or varied from an expected value a certain amount, then additional processing may be initiated including some automatic status checking and/or sending a truck to the access point site and installing a new battery and/or switching to a back-up battery already at the site. FIG. 9 also illustrates that the heart beat sub-routine of FIG. 8a preferably begins with a pre-amble sub-routine followed by the sending of the heart beat signal, e.g., as represented in FIG. 9 by ascii character “h”. The receive CHmon status routine is shown in FIG. 9 as including a read serial port sub-routine, and the store CHmon status routine is shown as including a write to status file sub-routine. As discussed above, this may alternatively include writing to a table and providing a pointer address, or providing a pointer to a table already available with the status information as stored by CHmon or PmonD preferably at the access point or alternatively at another location within the network that is accessible from the gateway workstation utilizing the gateway main program.

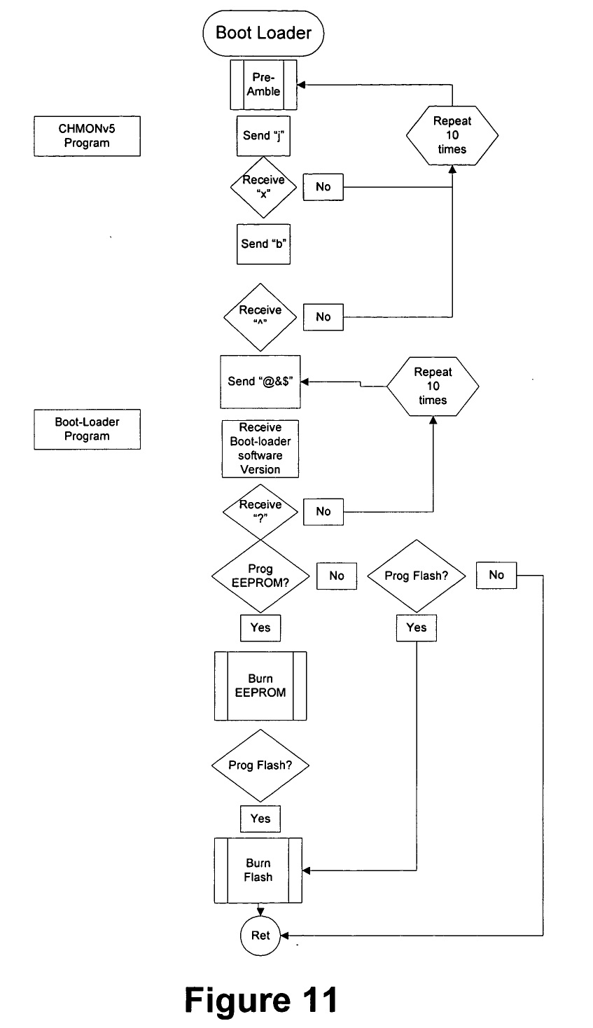

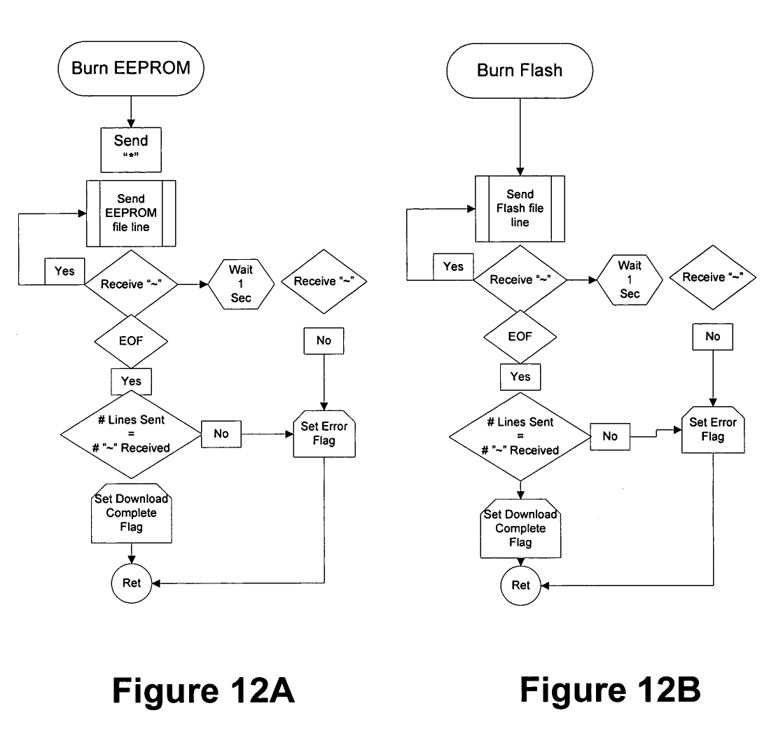

FIG. 11 illustrates a boot-loader sub-routine of the data acquisition and processing at the access point. Moreover, FIGS. 12a and 12b illustrate burn EEPROM and burn Flash sub-routines of the boot-loader routine. The communication and storage of the boot-loader routine of FIG. 11 is illustrative generally of a software or firmware programming update function that is run in response to a flash and/or EEPROM update command received initially from the gateway main program. A similar program module may be understood from the example of FIG. 11 for updating firmware that is preferably resident at the power supply, just as it may be utilized for updating the programming of the preferred flash card that is resident at the access point outside of the power supply box. Although not indicated at FIGS. 11 and 12a-12b, the system preferably runs an access point programming and/or power supply programming reset (or Mcu reset) routine to re-initialize the access point system with the updated programming instructions.

The other four commands illustrated at FIG. 8b that may be present within the command file, of the non-exhaustive exemplary listing shown, i.e., the disable heart beat command, update battery date command, cycle power command (or power cycling command) and reset mcu command (or access point programming or power supply programming module reset command), are also received at PmonD via a reading of the command file or otherwise. Note that the battery date value may be used to determine an expected lifetime left of the battery and/or an expected present battery voltage level that would be based on its age, the temperature, etc. In the case of the disable heart beat and update battery date commands, there may or may not be a communication with the power supply programming module CHmon of these commands prior to PmonD simply executing sub-routines such as writing the battery date and executing a do-not-send heart beat sub-routine, for carrying out the respective commands. The power supply module may however not respond particularly to the disable heart beat as a power cycle should be prevented whenever the heat beat has been disabled e.g., by initiating a power cycling or programming reset function or both (in general, the power cycling would include also a programming reset or initializing function following the return of power to the system). The cycle power and reset Mcu (or operating system or other programming restart) commands may be read by PmonD and initiated either by PmonD, or by CHmon upon further communication by PmonD. These routines are not shown in illustrative diagram examples because those skilled in the art will understand how to restart an operating system or other programming, and also understand how to turn power off and back on for a power supply system of an access point.

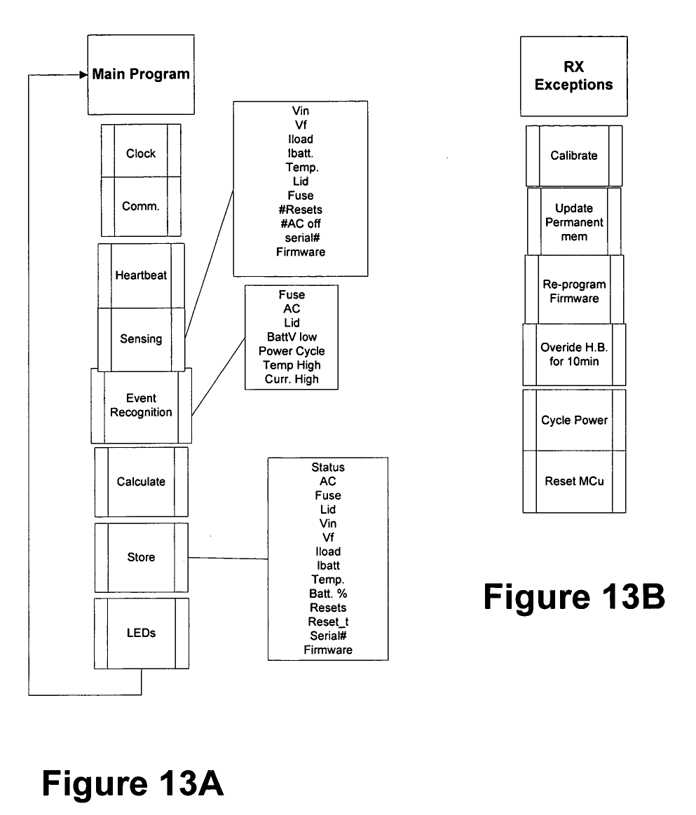

FIG. 13a is flow diagram illustrating data acquisition and processing at the power supply programming module CHmon which powers an access point of a wireless network in accordance with a preferred embodiment. The CHmon is one of the five basic parts of the SCADA system of the preferred embodiment that is particularly for monitoring parameters associated with the functioning of the power supply and communicating that information to the access point programming module PmonD and/or writing directly to its own status file or otherwise storing the information. CHmon preferably resides within the power supply box with one or more batteries that are charged by external power via an AC/DC converter. CHmon preferably comprises a complete manageable uninterruptible power supply (UPS) system that includes a circuit board and software or firmware combination (see FIG. 3). The combination of micro-controller unit (Mcu) and the software or firmware provides a platform for serial communication with the access point programming module PmonD.

As with the PmonD main programming routine described above with reference to FIG. 8a, the modules illustrated at FIG. 13a of the main programming of the power supply programming module CHmon are shown in a sequential arrangement. However, the modules may be run in different orders and at different and perhaps various relative times, and two or more modules may run contemporaneously. The clock and communication modules are shown as initiating modules of the power supply programming not immediately involving PmonD, although the communication module preferably includes a handshake routine with PmonD or otherwise a sharing of the communication protocols that they will use to exchange commands and power supply status or other information.

The CHmon heart beat module of FIG. 13c is the complement to that of PmonD as illustrated at FIGS. 8a and 9. The CHmon is prepared to listen for a heart beat signal following a proper pre-amble packet received from PmonD. When no heart beat is received within a certain time or number of clock cycles of when a heart beat is expected to be received from PmonD, e.g., 30 seconds or so from the time the last heart beat was received, then CHmon may cause power cycling off and back of the access point.

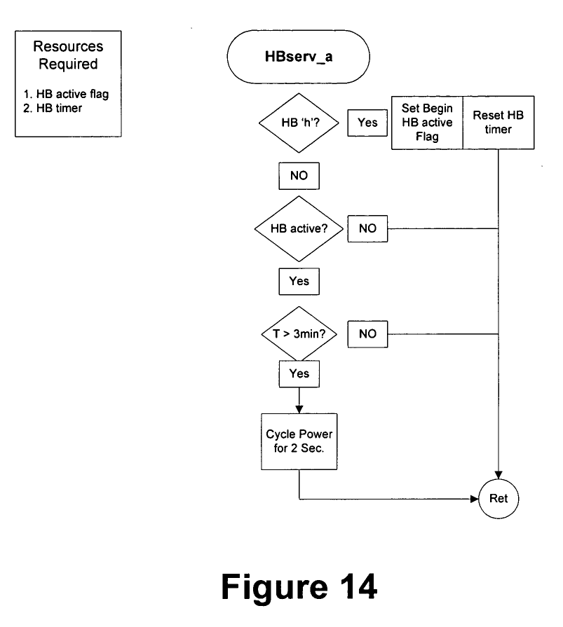

FIG. 14 illustrates a heart beat sub-routine of the data acquisition and processing at the power supply. It is determined whether a heart beat signal has been received, and if so, then a begin heart beat active flag is set and a heart beat timer is reset, such that the routine will run again when the next heart beat is expected, and in the meantime CHmon will presume that the access point is operating properly. If the heart beat signal is not received when expected, then CHmon attempts to determine whether the heart beat may simply not be active. For example, it may be disabled intentionally for some reason. A servicing agent or gateway main program operator may not wish for the system to cycle the power in response, so that then the system simply returns and waits to be re-initialized before it runs the heart beat routine again. If the heart beat routine is determined to be active, then CHmon is set to wait a certain amount of time, e.g., three minutes, for the heart beat signal to arrive later than expected. If that time passes, then the power supply programming module CHmon initiates a power cycling routine to power the access point down and then back up again in an attempt to fix the perceived problem.

When, on the other hand, the heart beat signal is received at or near the expected time, and thereby the power supply module CHmon is defaulted to continue processing with the understanding that the access point is operating properly, then the sensing module runs its routine. Referring back now to FIG. 13a, the sensing module senses multiple quantities for determining whether an event has occurred or is occurring, and for determining various requested status parameter levels. The sensed parameters may include the following non-exhaustive quantities: Vin (e.g., voltage input to power supply from AC/DC converter), Vf (e.g., voltage output to the access point antenna and supporting electronics and programming instructions), Iload (e.g., current flowing through access point equipment), Ibatt (e.g. current flowing from the power supply batteries), Temp. (e.g., temperature of the power supply), lid (e.g., whether the lid is open, or closed and unlocked, or closed and locked), fuse (e.g., whether the fuse is blown or operable, and perhaps its rating), as well as resets, AC on/off, serial number and/or firmware number.

Next, an event recognition module determines whether one or more events are occurring such as: fuse (e.g., whether the fuse is blown, or if the fuse is resettable such as with thermal fuses then whether the fuse is presently set), AC (e.g., whether the AC power is actively supplying energy to the power supply system via the DC converter), Lid (e.g., whether the lid is open or unlocked), BattV low (whether the voltage on the battery is below a certain threshold or a certain percentage below an expected value depending on its age or use, and the temperature, among perhaps other parameters affecting the battery voltage), Power Cycle (e.g., whether the power is presently being cycled), Temp. High (e.g., whether the temperature of the power supply box or of one or more critical locations in the box exceeds a threshold value), Curr. High (e.g., whether the load or battery current exceeds a threshold value).

The calculate module of FIG. 13a may provide the Mcu of the power supply programming module one or more mathematical sub-routines for determining quantities that have not been measured, but that may be calculated from quantities that have been sensed via the sensing sub-routine. In a store sub-routine, these calculated quantities and preferably some of the sensed quantities themselves are stored into a status file (either the status file of FIGS. 7a and 7b or a separate power supply programming module status file that may be read by PmonD before writing to a different status file that is accessible by the gateway main program. The exemplary listing shown at FIG. 13a in association with the store module includes AC, fuse and lid event flags (yes/true or no/false), a status quantity that may be some kind of status rating (e.g., 1-5, with 1 being poor indicating to change the battery or perform a reset or power cycling, and 5 being great such that no follow-up procedures are recommended), the Vin, Vf, Iload, Ibatt, Temp., resets, serial # and firmware version quantities taken directly from the sensing module preferably without further calculation, a batt % that was discussed above and may be a percentage of an expected voltage or maximum voltage of the battery, and a reset_t that may be indicative of a manual or other than ordinary programming reset or restart of the operating system for the power supply micro-controller unit (mcu). Finally, a LED module provides instructions for lighting localized LEDs so that a person who may be present at the access point site can see whether the programming is indicating that there may be faults or whether the system has been determined to be operating properly.

FIG. 13b illustrates a set of additional gateway main program commands, i.e., in addition to the status request command and perhaps other commands that may be communicated through the access point programming interface module PmonD to the power supply programming module CHmon, and that may be implemented by data acquisition and processing at the power supply. As mentioned above, in one embodiment the status request is defaulted to an “on” state so that CHmon runs status automatically upon receiving a heart beat from PmonD, and the update EEPROM and/or flash and update battery date commands may be implemented by PmonD without CHmon processing or communication being involved. In alternative embodiments, status commands may be communicated to CHmon from the gateway main program and/or from PmonD, and CHmon may be involved in further processing such that further modules than those provided at FIGS. 13a and 13b may be included in the power supply programming module CHmon resident at the power supply.

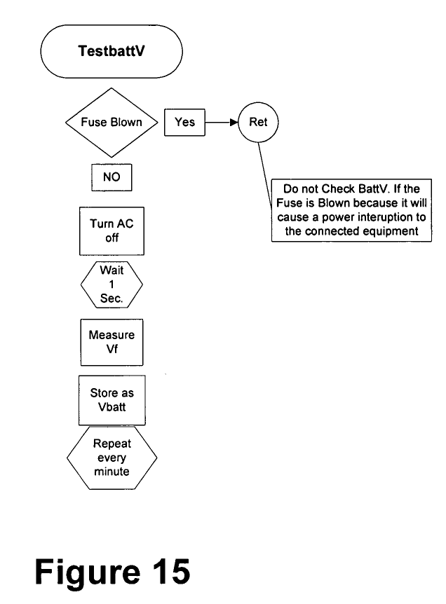

FIG. 15 illustrates a battery test sub-routine of the data acquisition and processing at the power supply. This procedure can be part of the sensing module of FIG. 13a, or may be a separate sub-routine that may be initiated by a gateway main program command, a PmonD communication, or that may be self-initiated by the power supply programming CHmon. A first check is whether a fuse may be blown, and if so, then further battery voltage checking is not performed as it will tend to cause a power interruption to connected equipment. If a fuse is not indicated as being blown, then AC is turned off briefly. After one second, the output battery voltage is measured and stored as Vbatt or Vf. This routine may be repeated periodically or when commands are issued. The AC would be turned back on following the checking so that the battery may continue to be charged by the external power.

While an exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the appended claims and structural and functional equivalents thereof.

In addition, in methods that may be performed according to preferred embodiments herein and that may have been described above, the operations have been described in selected typographical sequences. However, the sequences have been selected and so ordered for typographical convenience and are not intended to imply any particular order for performing the operations.

1. An access point of a wireless internet service provider (WISP) network that includes a supervisory control and data acquisition (SCADA) system, the access point including at least one antenna, a power supply and supporting electronics, and further including programming instruction modules that comprise:
(a) a power supply program module resident at the power supply for energizing the access point permitting wireless signals to be received and transmitted along a backbone of the wireless network;
(b) an access point program module resident at the access point for communicating with the power supply to process (i) commands relayed to the access point that are initiated from a central control console of the WISP network, and (ii) access point resident programming,
(c) wherein the central control console, and the access point and the power supply running their respective program modules communicate to maintain the access point or power supply. or both, in an operating mode within the network by identifying power supply or access point problems, or both, and preventing power supply disruptions by initiating power cycling, or an access point program module programming reset or a power supply program module programming reset, or combinations thereof.

2. The access point of claim 1, wherein the power supply module for processing (i) the commands relayed to the access point that are initiated from the central control console, and (ii) localized status sensing and communication programming configured to trigger an automatic power cycling when the power supply or other access point equipment is determined to not be operating properly.

3. The access point of claim 2, wherein the power supply module is further configured for processing a power cycling command.

4. The access point of claim 3, wherein the receipt of the cycle power command at the power supply is preceded by a pre-amble signal to validate the power cycling command.

5. The access point of claim 1, wherein the commands from the central control console comprise a status request command, a calibration command, one or more programming instruction updating commands, a heart beat function override command, a power cycling command or a reset command, or combinations thereof.

6. The access point of claim 1, wherein the commands from the central control console comprise a status request command, as well as a power cycling command, an access point programming reset command or a power supply programming reset command, or combinations thereof.

7. A power supply of an access point of a wireless internet service provider (WISP) network that includes a supervisory control and data acquisition (SCADA) system, the access point further including at least one antenna, supporting electronics and an access point program module, the power supply comprising a power supply program module resident at the power supply for communicating with the access point to process (a) commands relayed to the access point initiated from a central control console of the WISP network, and (ii) status sensing and communication programming configured to trigger an automatic power supply cycling, or an access point or power supply programming reset, or combinations thereof, when the power supply or other access point equipment is determined to not be operating properly.

8. The power supply of claim 7, the communicating with the access point for further processing an access point localized heart beat routine that facilitates the communicating with the access point of the status sensing and communication programming.

9. The power supply of claim 8, wherein the power supply module initiates a power cycling routine or an access point programming or power supply programming reset, or combinations thereof, when an expected heart beat signal is not received from the access point module.

10. The power supply of claim 7, wherein the power supply module further executes a battery test routine that checks and stores a battery voltage level periodically.

11. The power supply of claim 7, wherein the power supply module is further configured for processing a power cycling command.

12. The power supply of claim 7, wherein the power supply module is further configured for processing a power supply programming reset command.

13. A central control console of a wireless internet service provider (WISP) network that includes a supervisory control and data acquisition (SCADA) system for monitoring and controlling a plurality of access points each including at least one antenna, a power supply, supporting electronics and access point and power supply program modules, the central control console comprising a network-connected workstation running a central control program for exercising centralized access point control including communicating commands to and receiving status from the access points, wherein the access points communicate with their power supplies to automatically implement the commands initiated from the central control console in one or more localized routines, such that centralized control is provided while avoiding a substantial increase of network traffic.

14. The gateway of claim 13, wherein the commands communicated to the access point from the central control console comprise a status request that initiates a localized sub-routine at the access point resulting in a writing to a status file that is accessible by the central control console.

15. The gateway of claim 13, wherein the commands communicated to the access point that are initiated from the central control console comprise one or more programming instruction update commands.

16. The gateway of claim 15, wherein the update commands comprise an access point module update command or a power supply module update command, or both.

17. The gateway of claim 13, wherein the commands communicated to the access point that are initiated from the central control console comprise an automatic power cycling command.

18. The gateway of claim 13, wherein the commands communicated to the access point that are initiated from the central control console comprise an automatic access point programming reset command or an automatic power supply programming reset command, or both.

19. The gateway of claim 18, wherein the access point programming comprises the power supply programming plus additional access point interface programming.

20. A supervisory control and data acquisition (SCADA) method for monitoring and controlling from a central control console a plurality of access points each including at least one antenna, a power supply, supporting electronics and access point programming and power supply program modules, the method comprising:
(a) running a control program that is resident at the central control console; and
(b) exercising centralized access point control including communicating commands to and receiving status from the access point, wherein the access point running the access point program module communicates with the power supply running the power supply program module to automatically implement the commands initiated from the central control console in one or more localized routines, such that centralized control is provided while avoiding a substantial increase of network traffic.

21. The method of claim 20, further comprising communicating a status request command that initiates a localized sub-routine at the access point resulting in an updating of a status file that is accessible by the central control console.

22. The method of claim 20, further comprising communicating one or more programming instruction update commands.

23. The method of claim 22, wherein the update commands comprise an access point module programming update command or a power supply module programming update command, or both.

24. The method of claim 20, further comprising communicating an automatic power cycling command to the access point.

25. The method of claim 20, further comprising communicating an automatic access point programming reset command or a power supply programming reset command, or both, to the access point.

26. The method of claim 20, further comprising communicating a status request command to the access point, receiving a power supply status, and communicating to the access point a power cycling command, or an access point programming reset command, or a power supply programming reset command, or combinations thereof.

27. A method of operating an access point of a wireless internet service provider (WISP) network that includes a supervisory control and data acquisition (SCADA) system, the access point including at least one antenna, a power supply and supporting electronics, and further including power supply and access point program modules, the method comprising:
(a) energizing the power supply for the access point permitting wireless signals to be received and transmitted including running a power supply program module resident at the power supply;
(b) running an access point program module resident at the access point;
(c) communicating commands from the access point to the power supply that are initiated from a central control console of the WISP network; and
(d) communicating commands from the access point to the power supply based on status signals from the power supply for maintaining the access point in an operating mode within the network by preventing power supply disruptions.

28. The method of claim 27, further comprising triggering an automatic power cycling when the power supply or other access point equipment is determined to not be operating properly.

29. The method of claim 28, further comprising initiating a power supply programming reset routine or an access point programming reset routine, or both.

30. The method of claim 28, further comprising communicating a pre-amble signal to validate the power cycling command.

31. The method of claim 27, wherein the commands initiated from the central control console comprise a status request command, a calibration command, one or more programming instruction updating commands, a heart beat function override command, a power cycling command, an access point programming reset command, or a power supply programming reset command, or combinations thereof.

32. The method of claim 27, wherein the maintaining of the access point comprises identifying power supply or access point problems, or both, and preventing power supply disruptions by initiating power cycling, an access point programming reset or a power supply programming reset, or combinations thereof.

33. A method of operating a power supply of an access point of a wireless internet service provider (WISP) network that includes a supervisory control and data acquisition (SCADA) system, the access point further including at least one antenna, supporting electronics and an access point program module, the power supply comprising a power supply program module resident at the power supply, the method comprising:
(a) communicating with the access point to process commands initiated from a central control console of the WISP network;
(b) sensing a power supply status; and
(c) communicating with the access point for triggering an automatic power cycling routine, an access point programming reset routine, or a power supply programming reset routine, or combinations thereof, when the power supply or other access point equipment is determined to not be operating properly.

34. The method of claim 33, further comprising processing an access point localized heart beat routine that facilitates the communicating with the access point and sensing of the power supply status.

35. The method of claim 34, further comprising initiating a power cycling routine when an expected heart beat signal is not received from the access point module.

36. The method of claim 33, further comprising executing a battery test routine including checking and storing a battery voltage level periodically.

37. The method of claim 33, further comprising processing a power cycling command.

38. The method of claim 33, further comprising processing an automatic access point programming reset command or a power supply programming reset command, or both.

39. One or more processor readable storage devices having processor readable code embodied thereon, said processor readable code for programming one or more processors to perform a supervisory control and data acquisition (SCADA) method for monitoring and controlling from a central control console a plurality of access points each including at least one antenna, a power supply, supporting electronics and access point programming and power supply program modules, the method comprising:
(a) running a control program that is resident at the central control console; and
(b) exercising centralized access point control including communicating commands to and receiving status from the access point, wherein the access point running the access point program module communicates with the power supply running the power supply program module to automatically implement the commands initiated from the central control console in one or more localized routines, such that centralized control is provided while avoiding a substantial increase of network traffic.

40. The storage devices of claim 39, the method further comprising communicating a status request command that initiates a localized sub-routine at the access point resulting in an updating of a status file that is accessible by the central control console.

41. The storage devices of claim 39, the method further comprising communicating one or more programming instruction update commands.

42. The storage devices of claim 41, wherein the update commands comprise an access point module programming update command or a power supply module programming update command, or both.

43. The storage devices of claim 39, the method further comprising communicating an automatic power cycling command to the access point.

44. The storage devices of claim 39, the method further comprising communicating an automatic access point programming reset command or a power supply programming reset command, or both, to the access point.

45. The storage devices of claim 39, the method further comprising communicating a status request command to the access point, receiving a power supply status, and communicating to the access point a power cycling command, an access point programming reset command or a power supply programming reset command, or combinations thereof.

46. One or more processor readable storage devices having processor readable code embodied thereon, said processor readable code for programming one or more processors to perform a method of operating an access point of a wireless internet service provider (WISP) network that includes a supervisory control and data acquisition (SCADA) system, the access point including at least one antenna, a power supply and supporting electronics, and further including power supply and access point program modules, the method comprising:
(a) energizing the power supply for the access point permitting wireless signals to be received and transmitted including running a power supply program module resident at the power supply;
(b) running an access point program module resident at the access point;
(c) communicating commands from the access point to the power supply that are initiated from a central control console of the WISP network; and
(d) communicating commands from the access point to the power supply based on status signals from the power supply for maintaining the access point in an operating mode within the network by preventing power supply disruptions.

47. The storage devices of claim 46, the method further comprising triggering an automatic power cycling when the power supply or other access point equipment is determined to not be operating properly.

48. The storage devices of claim 47, the method further comprising initiating a power supply programming reset routine or an access point programming reset routine, or both.

49. The storage devices of claim 48, the method further comprising communicating a pre-amble signal to validate the power cycling command.

50. The storage devices of claim 46, wherein the commands from the central control console comprise a status request command, a calibration command, one or more programming instruction updating commands, a heart beat function override command, a power cycling command, an access point programming reset command or a power supply programming reset command, or combinations thereof.

51. The storage devices of claim 46, wherein the maintaining of the access point comprises identifying a power supply or access point problem, or both, and preventing power supply disruptions by initiating a power cycling, an access point program module programming reset, or a power supply program module programming reset, or combinations thereof.

52. One or more processor readable storage devices having processor readable code embodied thereon, said processor readable code for programming one or more processors to perform a method of operating a power supply of an access point of a wireless internet service provider (WISP) network that includes a supervisory control and data acquisition (SCADA) system, the access point further including at least one antenna, supporting electronics and an access point program module, the power supply comprising a power supply program module resident at the power supply, the method comprising:
(a) communicating with the access point to process commands initiated from a central control console of the WISP network;
(b) sensing a power supply status; and
(c) communicating with the access point for triggering an automatic power cycling routine, an access point programming reset routine, or a power supply programming reset routine, or combinations thereof, when the power supply or other access point equipment is determined to not be operating properly.

53. The storage devices of claim 52, the method further comprising processing an access point localized heart beat routine that facilitates the communicating with the access point and sensing of the power supply status.

54. The storage devices of claim 53, the method further comprising initiating a power cycling routine when an expected heart beat signal is not received from the access point module.

55. The storage devices of claim 52, the method further comprising executing a battery test routine including checking and storing a battery voltage level periodically.

56. The storage devices of claim 52, the method further comprising processing a power cycling command.

57. The storage devices of claim 52, further comprising processing an automatic access point programming reset command or a power supply programming reset command, or both.
